(19) United States
(12) Patent Application Publication
(10) Pub. No.: US 2012/0299209 A1
(43) Pub. Date: Nov. 29, 2012

(54) DEVICE AND METHOD FOR THE LONGITUDINAL STRETCHING OF A FILM WEB

(76) Inventors: Bartholomeus Trommelen, Gronau (DE); Juergen Linkies, Lienen (DE); Thomas Niebruegge, Bad Laer (DE)

(21) Appl. No.: 13/509,099

(22) PCT Filed: Nov. 2, 2010
(86) PCT No.: PCT/EP10/66649

§ 371 Date: Aug. 8, 2012

(30) Foreign Application Priority Data
Nov. 10, 2009 (DE) 10-2009-046-5928

(51) Int. Cl. B29C 43/24

(52) U.S. Cl. 264/40.7; 425/145

(57) ABSTRACT

The invention describes a device (1) that is intended for longitudinally stretching film webs (2) and that comprises a plurality of rollers (5, 6, 9, 10, 11, 12, 13, 18, 19), some of which are temperature control rollers, and some of which (9-13) form stretching gaps (22), in which the film web (2) can be stretched.

At least one of the rollers (5, 6, 9, 10, 11, 12, 13, 18, 19) has a drive that is torque controlled.

The invention relates to a device for longitudinally stretching a film web, as defined in the preamble of claim 1, and a corresponding method, as defined in the preamble of claim 7.

The properties of thermoplastic films can be modified in a targeted way by stretching. Such properties are, for example, the transparency or the strength. Such a stretching operation, which can take place in the transverse and/or longitudinal direction of the film web, can be performed in-line directly after the extrusion process. However, the extruded film can also be wound up and then fed to the device for longitudinal stretching after having been unwound again (“off-line processing”).

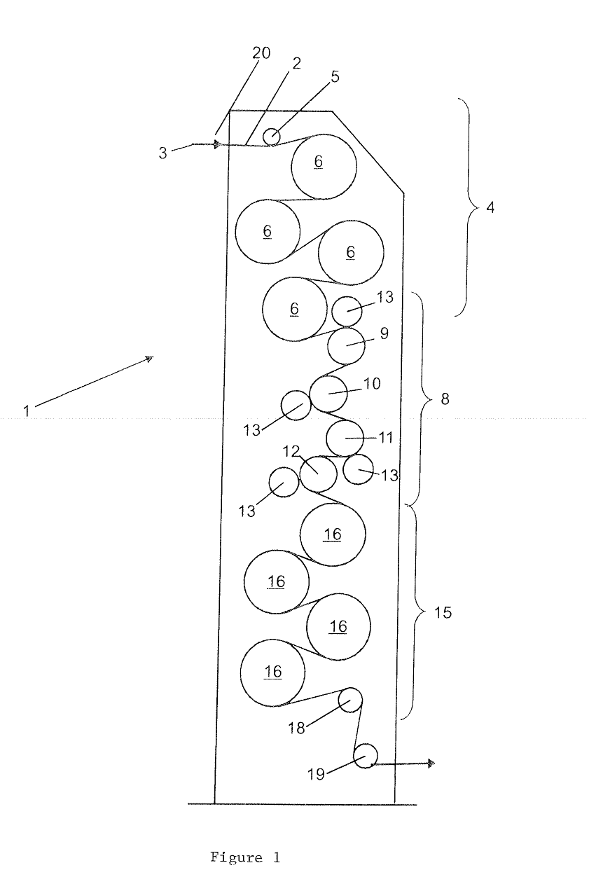

The published document WO 2006/063641 A1 shows such a device for longitudinal stretching a film web—in this case, a multi-step device—in its FIG. 1. Frequently such a device comprises:
at least one heating roller, with which the film web can be heated;
at least one cooling roller, with which the film web can be cooled down again; and
at least one stretching unit, in which the film web can be stretched in the longitudinal direction of said film web; and the stretching unit comprises a first transport roller, which has a first circumferential speed during the stretching operation and a second transport roller, which is disposed downstream of the first transport roller as seen in the direction along the transport path of the film web and which has a second circumferential speed, wherein the second circumferential speed is greater than the first transport speed.

As a rule, such stretching units also comprise annealing or tempering rollers that are positioned between the stretching unit and the cooling rollers. It is often the case that these rollers already exhibit a lower temperature than the heating rollers, but are temperature controlled in such a way that they prevent the film from cooling too rapidly.

A distinction is often made between cooling rollers and annealing rollers, because the annealing rollers are traversed by oil, and the cooling rollers are traversed by water.

It is a fact that the bulk of the actual stretching process in the stretching units is done between the actual stretching rollers. The situation may arise in the stretching units that the length of the film is extended by integral factors.

However, even rollers that do not define the stretching gap(s) of the longitudinal stretching unit are operated at a different circumferential speed that ensures that a certain web tension, which counteracts the formation of folds, is maintained between the different rollers. Such folds cause damage to the film.

Despite all of these measures it has been demonstrated that the longitudinal stretching of film webs in the described devices has not only the desired effects on the transparency and the strength of the film, but it also leads to damages. Therefore, the object of the present invention is to limit these damages.

This engineering object is achieved in that a stretching unit, conforming to its genre, has at least one roller that is speed controlled.

As stated above, a stretching unit, conforming to its genre, has a plurality of rollers. Some of these rollers have the function of allowing the film to reach a suitable stretching temperature, before it is stretched. After the stretching process the film web is allowed to reach in stages again a lower temperature. Downstream of the stretching unit there are often the annealing or tempering rollers that are warmer than the surrounding area and continue to hold the film web at a certain temperature. This feature is supposed to facilitate the crystallization processes downstream of the actual stretching process and to prevent the film from being damaged by cooling down too fast. Therefore, the annealing or tempering rollers, just as to some extent the heating rollers, are often heated with a specific heating fluid, like oil.

It is often the case that at the end of the process the film is cooled by means of cooling rollers, through which water often flows. In the present publication the heating, annealing and cooling rollers are discussed under the umbrella term temperature control rollers. It is also possible to carry out the actual stretching process using at least one temperature control roller. However, it is often the case that the rollers, which form the stretching unit, are likewise not temperature controlled. However, a stretching unit often has not only temperature control rollers and stretching rollers, but also pressure rollers and guide rollers.

Some of the rollers are driven. Owing to the spasmodic development of drive engineering in the past decades, a roller is often assigned a drive. In this case the word drive is understood to mean the torque adjuster—that is, as a rule an electric motor. The concept drive device is defined herein as the functional unit comprising an electric motor and a frequency rectifier.

The present invention exploits the knowledge that some of the damage to the film web is caused by the high web tension. In this respect it is surprising that the damage is incurred not even exclusively in the stretching unit, but rather also between the temperature control rollers that are positioned upstream and downstream thereto. At this point the film has not reached the correct stretching temperature yet, or the film is no longer at the correct stretching temperature, but rather is still being elongated by the forces required to maintain the web tension. Therefore, the measures proposed according to the invention may be advantageous in the stretching units, but they are typically even more commendable outside these stretching units.

To begin with, a minimum speed can be preset for each roller, which is provided with a speed control mode. Usually in this case then an “advance” is adjusted (for example, 10% faster than the roller that is disposed upstream in the web travel direction). Presetting the absolute values (for example, for the circumferential speed) is also conceivable. Then the torque control mode can limit the maximum torque that has to be generated. This variable can then be entered as a function of the film to be stretched.

It is advantageous that the display device shows the mechanical values that relate to the web tension. The simplest solution in this case is to display the torque values, for example, in Newton meters. Of course, derived values, like the force acting on the film, can also be displayed.

When the stretching device is running, it is advantageous that a plurality of rollers are operated in a speed controlled mode. All directly driven rollers could also be operated in this way. However, as a rule the speed ratios between the rollers are specified in the stretching units, so that the film also attains the desired properties.

In particular, if a plurality of rollers are operated in a torque controlled mode, it is advantageous to dispense with the torque control mode after a first time interval and to carry out the control according to the roller speed or the relative speed of certain rollers when, for example, there is a defined number of rollers. In this way the operating parameters, which have prevented too High a force from being exerted on the film in the first time interval, can be virtually frozen—that is, can be continued for a longer period of time during a second time interval. This feature enables a largely optimized operation of the stretching unit in the second time interval; and this optimized operation is not disrupted or slowed down by interfering control processes due to control processes at the front roller as seen in the web travel direction.

It is especially advantageous if the torque control mode of the rollers has already begun at the time that the stretching unit begins to operate. In this case it is possible to adjust the optimized web tension between the individual rollers or the roller gaps with a reasonable time delay, said optimization being important for a damage-free production.

It is very advantageous if the various methods that are presented in this publication are carried out in an automated way by the control module of the longitudinal stretching unit. To this end the control module can be adjusted accordingly. This adjustment is done by a programming operation. This programming operation can also be performed using data carriers or by modern data communications methods, like e-mail, chatting or remote maintenance methods.

Additional exemplary embodiments of the invention are apparent from the description of the subject matter and the claims.

The single FIGURE shows in schematic form the layout of a device as defined in the preamble.

The FIGURE shows a device 1 for longitudinally stretching a film web 2, which is guided along a transport path in the transport direction 3. The film web 2 is supplied by an extrusion system or an unwinding device. Then the film web 2 passes through a guide roller 5, before it runs in succession over four heating rollers 6, which are temperature controllable, in the heating unit 4.

After the film web 2 has been heated in this way to or above the plasticizing temperature, it is fed into the stretching unit 8. The stretching unit 8 comprises transport rollers 9, 10, 11, 12; and the roller pairs 9 and 10 and the rollers pairs 11 and 12 form in each case a so-called stretching gap. In this case the rollers 10 and 12 have a higher circumferential speed than their assigned rollers 9 and 11. However, the rollers 10 and 11 can have the same circumferential speed. Each of the four aforementioned transport rollers is assigned a pressure roller 13, which makes sure that the film web 2 lies securely on the transport rollers and cannot slide through.

In the cooling unit 15 the film web 2 is guided over the cooling rollers 16. The section of the cooling unit 15 that is located in the front as seen in the web travel direction can also have additional rollers, the so-called annealing rollers, which have already been described in the introductory part, but are not depicted herein.

After the film web 2 has passed through two additional guide rollers 18 and 19, it can be fed to a winding device or any device for further processing. A description and presentation of the control modules, cables, motors and frequency converters have been dispensed with herein.

### LIST OF REFERENCE NUMERALS

| | |
|---|---|
| 1 | device for longitudinally stretching a film web 2 |
| 2 | film web |
| 3 | transport direction |
| 4 | heating unit |
| 5 | guide roller |
| 6 | heating roller |
| 7 | |
| 8 | stretching unit |
| 9 | transport roller |
| 10 | transport roller |
| 11 | transport roller |
| 12 | transport roller |
| 13 | pressure roller |
| 14 | |
| 15 | cooling unit |
| 16 | cooling roller |
| 17 | |
| 18 | guide roller |
| 19 | guide roller |
| 20 | arrow in the direction of movement of the web 3 |

1. Device (1) that is intended for longitudinally stretching film webs (2) and
that comprises a plurality of rollers (5, 6, 9, 10, 11, 12, 13, 18, 19),
some of which are temperature control rollers,
and some of which (9-13) form stretching gaps (22), in which the film web (2) can be stretched,
characterized in that
at least one of the rollers (5, 6, 9, 10, 11, 12, 13, 18, 19) has a drive that is torque controlled.

2. Device (1), as claimed in claim 1,
characterized in that
the at least one roller (A) has a drive device, in which the torque forming current, which is fed to the motor of at least one roller (5, 6, 9, 10, 11, 12, 13, 18, 19), can be measured.

3. Device (1), as claimed in claim 1,
characterized in that
the at least one roller (5, 6, 9, 10, 11, 12, 13, 18, 19) is a cooling roller (16) and/or an annealing roller and/or a heating roller (6).

4. Device (1), as claimed in claim 1,
characterized by
a control module, with which a minimum speed can be preset for at least one roller (5, 6, 9, 10, 11, 12, 13, 18, 19).

5. Device (1), as claimed in claim 4,
characterized in that
the minimum speed of at least one roller can be adjusted as a function of the speed of another roller (5, 6, 9, 10, 11, 12, 13, 18, 19).

6. Device (1), as claimed in claim 1,
characterized by
a control module that is designed in such a way that it actuates the display device for displaying mechanical values that relate to the web tension.

7. Method that is intended for longitudinally stretching a film web (2) and
wherein the film web (2) is guided past a plurality of rollers (5, 6, 9, 10, 11, 12, 13, 18, 19),
wherein at least some (6, 16) of the rollers (5, 6, 9, 10, 11, 12, 13, 18, 19) control the temperature of the film web (2);
and the film web (2) is stretched in at least one stretching gap (22) due to a differing circumferential speed of the rollers (9, 10, 11, 12) defining the stretching gap,
characterized in that
the rotational movement of at least one of the rollers (5, 6, 9, 10, 11, 12, 13, 18, 19) is torque controlled.

8. Method, as claimed in claim 7,
characterized in that
the movement of a plurality of the rollers (5, 6, 9, 10, 11, 12, 13, 18, 19) is torque controlled.

9. Method, as claimed in claim 1,
characterized in that
when the rotational speed of the roller (5, 6, 9, 10, 11, 12, 13, 18, 19) is controlled, a minimum speed is preset; but the maximally retrievable torque for reaching the minimum speed is limited by the torque control mode.

10. Method, as claimed in claim 1,
characterized in that
the at least one roller (5, 6, 9, 10, 11, 12, 13, 18, 19) is operated in a torque controlled mode during a first time interval;
and after the expiration of the first time interval the torque control mode is dispensed with.

11. Method, as claimed in claim 1,
characterized in that
the roller (5, 6, 9, 10, 11, 12, 13, 18, 19) is operated as a function of the speed of the roller situated upstream of said roller in the web travel direction during the second time interval.

12. Method, as claimed in claim 1,
characterized in that
the at least one roller (5, 6, 9, 10, 11, 12, 13, 18, 19) is torque controlled during a period of time, in which the longitudinal stretching process begins.
